(19) United States
(12) Patent Application Publication
(10) Pub. No.: US 2005/0050964 A1
(43) Pub. Date: Mar. 10, 2005

(54) APPARATUS AND METHOD OF MEASURING WASTEWATER CONCENTRATION FOR DETERMINING DISCHARGE RATE

(76) Inventors: Michael Tang, Hsinchu (TW); Chao-Te Li, Hsinchu (TW); Chih-Chin Tsai, Hsinchu (TW); Wen-Tay Wu, Hsinchu (TW); Jia-Lih Shyu, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/711,236

(22) Filed: Sep. 3, 2004

(30) Foreign Application Priority Data
Sep. 9, 2003 (TW) 92124842

(51) Int. Cl. C02F 3/00

(52) U.S. Cl. 73/861

(57) ABSTRACT

An apparatus of measuring concentration of wastewater is provided for determining discharge rate of wastewater from a wastewater-collecting tank. The apparatus includes a mixing tank, a measuring tank, a water supply unit, a wastewater supply unit, a concentration detector, a controller, and a monitor. The measuring tank is communicated with the mixing tank, and the water supply unit is communicated with the mixing tank. Further, the concentration detector is located in the measuring tank, the controller is electronically connected respectively with all other devices, and the monitor is electronically connected with the controller to show the operating status of every device. The apparatus is capable of measuring real concentration of wastewater in the wastewater-collecting tank, and results of which can be used to adjust the discharge rate from the wastewater-collecting tank within a safe range.

### CROSS REFERENCE TO RELATED APPLICATIONS

This application claims the priority benefit of Taiwanese application serial No. 92124842, filed on Sep. 9, 2003.

### BACKGROUND OF INVENTION

1. Field of the Invention

The present invention relates to an apparatus and a method of measuring wastewater concentration, and more particularly to an apparatus and a method of measuring wastewater concentration for determining discharge rate of the wastewater.

2. Description of the Related Art

Fabrication processes of Very Large Scale Integration (VLSI) usually generate a large amount of wastewater, since a large amount of water are used in the processes for washing and purification purposes. Such wastewater is usually toxic, and, if mixed with other waste materials generated in the processes, can form flammable organic waste liquids, which are difficult to be treated due to toxicity and/or flammability.

In general, wastewater generated from different fabrication processes in a manufacturer is collected into a collecting tank. Contents and concentration of the wastewater in the collecting tank are then measured. Thereafter, the results of the measurement are used for adjusting discharge rate of the wastewater so as to control the discharge rate within a safe range of operational load of the wastewater treatment facilities.

In a process of measuring the wastewater concentration in a collecting tank, however, the concentration is often higher than the upper threshold of the concentration measurable by the detector, where the real concentration of the wastewater cannot be measured. As a consequence, problems occur. For instance, due to the failure of measuring the real concentration of the wastewater, an operator may not aware of the risk of potential harm if exposed in a danger or harmful working environment caused by the wastewater. On the other hand, the failure of accurately measuring concentration of the wastewater may cause such problems as the discharge rate to treatment facilities is in excess of that allowed by the safe load of the treatment facilities.

Although more advanced concentration detectors with a higher measurable threshold may be used to solve these problems, costs of the apparatus will be substantially increased. Thus, the use of such detectors is often not desirable.

### SUMMARY OF INVENTION

In view of the above, it is an object of the present invention to provide an apparatus and a method to measure wastewater concentration for determining discharge rate of wastewater, while apparatus is suitable for measuring real concentration of wastewater, and results of the measurement can be used to adjust the discharge rate within a safe range so as to prevent operators from being exposed in a hazardous working environment.

It is another object of the present invention to provide an apparatus and a method to measure wastewater concentration for determining discharge rate of wastewater, such that the higher costs on apparatus for measuring wastewater with high concentration can be avoided.

It is a further object of the present invention to provide an apparatus and a method to measure wastewater concentration for determining discharge rate of wastewater, while the method is suitable for measure real concentration of wastewater with a high concentration.

To achieve the above and other objectives, the present invention provides an apparatus of measuring wastewater concentration. Results of the measurement can be used to determine discharge rate of the wastewater from a wastewater-collecting tank. The apparatus includes a mixing tank, a measuring tank, a water supply unit, a wastewater supply unit, a concentration detector, a controller, and a monitor. Wherein, the mixing tank has a first pipeline which connects the measuring tank and the mixing tank, the water supply unit has a second pipeline which connects the water supply unit and the mixing tank, and the wastewater supply unit has a third pipeline which connects the wastewater supply unit and the mixing tank. Further, the concentration detector is located in the measuring tank. The controller is electronically connected with water supply unit, the wastewater supply unit, and the concentration detector, respectively, while the monitor is electronically connected with the controller to display the operating status of the water supply unit, the wastewater supply unit, and the concentration detector. In addition, the apparatus further includes a pH detector located in the measuring tank, and a pH adjusting reagent supply unit for adding pH-adjusting reagent into the measuring tank, so that pH value of the wastewater is adjusted and the wastewater is subsequently discharged from the measuring tank.

Since each operating unit of the above apparatus is electronically connected with the controller, an operator is able to monitor the operating status of the apparatus through the monitor, and to input relevant parameters from the controller to control the operation of the apparatus. Hence, this apparatus can be automatically controlled.

The present invention also provides a method to measure wastewater concentration for determining the discharge rate of the wastewater. The method is used to measure the wastewater concentration in a wastewater-collecting tank, and then to determine the discharge rate from the wastewater-collecting tank so as to control the discharge rate within a safe range. The method first includes a step of mixing certain amount of wastewater from the wastewater-collecting tank with water to obtain a mixture. Thereafter, the concentration of the mixture is detected by a concentration detector for calculating the real concentration of the wastewater in the collecting tank, and the real concentration is used to determine the discharge rate of the wastewater from the collecting tank for adjusting the discharge rate within a safe range.

Particularly, when the detected value by the foregoing concentration detector equals to the allowable upper threshold of the detector, a certain amount of wastewater is retaken from the collecting tank and is mixed with water in a higher dilution to obtain a second mixture. Next, concentration of the second mixture is detected by the concentration detector for calculating the real concentration of the wastewater in the collecting tank, and the real concentration is used to determine the discharge rate of the wastewater from the collecting tank.

Therefore, by use of the foregoing method, a sample of wastewater taken from a collecting tank is first diluted, concentration of the diluted sample is measured, and, based on the measured concentration, the real concentration of the wastewater in the collecting tank is then calculated. The dilution procedure can be carried out in multiple times so as to make the concentration detected by the detector lower than the upper threshold of the detector, such that the real concentration of the wastewater in the collecting tank can be subsequently calculated. Thus, the method of the present invention can be used to measure reliably wastewater concentration and to determine accurately an appropriate discharge rate from the collecting tank to treatment facilities.

Moreover, the present invention provides that real concentration of wastewater with a substantially high concentration can be accurately measured through the multiple dilutions approach, so that more expansive concentration detectors with higher threshold are not required, and costs of the measurement apparatus can be reduced.

It is to be understood that both the foregoing general description and the following detailed description are exemplary, and are intended to provide further explanation of the invention as claimed.

### BRIEF DESCRIPTION OF DRAWINGS

FIG. 1 is a diagraph schematically showing an apparatus for measuring concentration of chemicals in wastewater according to one embodiment of the present invention.

### DETAILED DESCRIPTION

As mentioned above, wastewater generated from different fabrication processes in a manufacturer is generally collected in a collecting tank. Contents and concentration of the wastewater in the collecting tank are then measured. The result of the measurement is consequently used for adjusting discharge rate of the wastewater so as to control the discharge within a safe range of operating load of wastewater treatment facilities. Apparently, the discharge rate from the wastewater-collecting tank directly affects the efficiency of the subsequent wastewater treatment facilities, and the discharge rate is related to the concentration of the wastewater. To show how to measure wastewater concentration in a collecting tank, a measuring apparatus is described according to one embodiment of the present invention as follows.

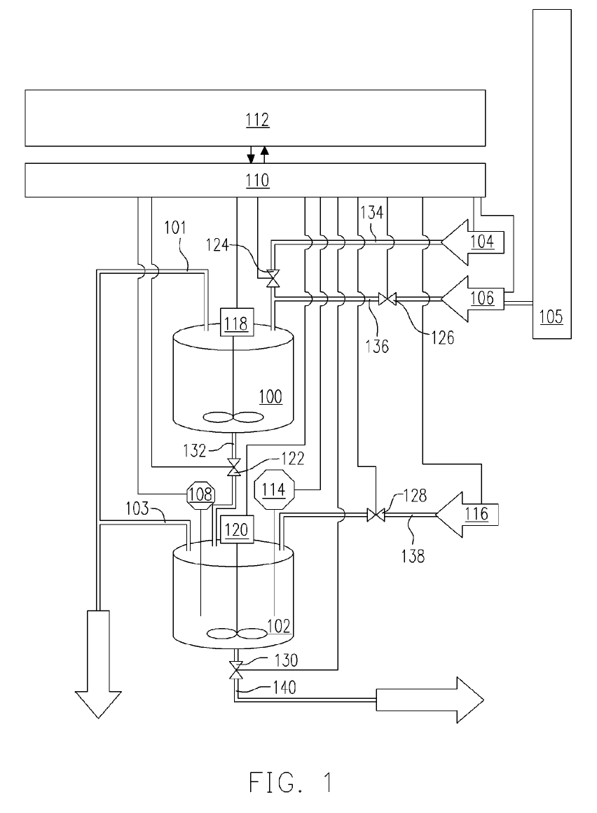

FIG. 1 illustrates schematically an apparatus of measuring wastewater concentration according to one embodiment of the present invention. The apparatus includes a mixing tank 100, a measuring tank 102, a water supply unit 104, a wastewater supply unit 106, a concentration detector 108, a controller 110 with a monitor 112, stirrers 118 and 120, control valves 122, 124 and 126, and pipelines 132, 134 and 136.

The measuring tank 102 is communicated with the mixing tank 100 via the pipeline 132, and the control valve 122 can be installed on the mixing pipeline 132 to control flow rate from the mixing tank 100 to the measuring tank 102. The water supply unit 104 is communicated with the mixing tank 100 via the pipeline 134, and the control valve 124 can be installed on the pipeline 134 to control flow rate from the water supply unit 104 to the mixing tank 100. Further, the wastewater supply unit 106 in communicated with the mixing tank 100 via the pipeline 136, and the control valve 126 can be installed on the pipeline 136 to control flow rate from the wastewater supply unit 106 to the mixing tank 100. In addition, the wastewater supply unit 106 is communicated with the wastewater-collecting tank 105, which contains wastewater collected from different fabrication sections of the plant.

The concentration detector 108 is located in the measuring tank 102 to measure wastewater concentration in the measuring tank 102. If the wastewater contains hydrofluoric acid, the concentration to be measured is of, for example, hydrofluoric ion.

On the other hand, the controller 110 is electronically connected with the water supply unit 104, the wastewater supply unit 106, the concentration detector 108, and each of the control valves 122, 124 and 126, respectively. The monitor 112 is electronically connected with the controller 110 to display the operating status of the water supply unit 104, the wastewater supply unit 106, the concentration detector 108, and the control valves 122, 124 and 126.

Moreover, overflow pipelines 101 and 103 can be installed respectively on the mixing tank 100 and the measuring tank 102. The overflow pipelines can be used, when too much wastewater is filled in the mixing tank 100 and/or the measuring tank 102, to carry away the surplus wastewater.

The apparatus can further include stirrers, 118 and 120, installed in the mixing tank 100 and the measuring tank 102, respectively, to mix thoroughly liquids injected into the tanks. The stirrers 118 and 120 are electronically connected with the controller 110.

Further, the apparatus can include a pH detector located in the measuring tank 102 to measure the pH value of the wastewater in the collecting tank 102. The pH detector is electronically connected with the controller 110. Moreover, the apparatus can include a pH-adjusting reagent supply unit 116, connected with the measuring tank 102 via a pipeline 138, for neutralizing the wastewater in the measuring tank 102. A control valve 128 can be further installed on the pipeline 138 for controlling flow rate from the pH-adjusting reagent supply unit 116 to the measuring unit 102, while the control valve 128 is electronically connected with the controller 110.

Of cause, the apparatus can also include a pipeline 140 and a control valve 130 for discharging wastewater in the measuring tank 102 after measured, while the control valve 103 is electronically connected with the controller 110.

Since each operating unit of the above apparatus is electronically connected with the controller, an operator is able to monitor the operating status of the apparatus through the monitor, and to input relevant parameters from the controller to control the operation of the apparatus. Hence, this apparatus can be automatically controlled.

The following is a description on a method of measuring wastewater concentration by using the foregoing apparatus for determining discharge rate of wastewater from a collecting tank to treatment facilities and controlling the discharge rate within a safe range. In the following process, the controller 110 controls each of the operating units, and operating status of each unit is displayed on the monitor 112.

First, the control valve 124 is opened so as to let a certain amount of water flow from the water supply unit 104 to the mixing tank 100 through the pipeline 134. The injected amount of water is adjusted by the injection time. The control valve 124 is subsequently closed.

Next, after the stirrer 118 is started, the control valve 126 is opened to let a certain amount of wastewater to flow from the wastewater-collecting tank 105 to the mixing tank 100 through the wastewater supply unit 106 and the pipeline 136. The injected amount of wastewater is adjusted by injection time, and the wastewater contains, for example, hydrofluoric acid, nitric acid, hydrochloric acid, sodium hydroxide, or organic solvents. In addition, the stirrer 118 is used to make the wastewater mixed thoroughly with water to form a mixture, while the stirring time of the stirrer 118 can be adjusted according to specific requirement. Of cause, if the injected amount of wastewater and water is larger than the volume of the mixing tank 100, the surplus can be discharged via the overflow pipeline 101. The control valve 126 is subsequently closed.

The control valve 122 is then opened to let the mixture to flow from the mixing tank 100 to the measuring tank 102 through the pipeline 132, while the injected amount of the mixture is adjusted by the injection time. Of cause, if the amount of the injected mixture is large than the volume of measuring tank 102, the surplus mixture can be discharged via the overflow pipeline 103. The control valve 122 is subsequently closed. The stirrer 120 is started to stir the mixture thoroughly for a certain period of time, and then is stopped.

Thereafter, the concentration detector 108 is used to measure concentration of the mixture (diluted waste liquid) in the measuring tank 102. If the waste liquid contains hydrofluoric acid, the concentration to be measured is of, for example, hydrofluoric ion. For the measurement, the controller 110 is used to calculate the degree of dilution of the mixture based on the amounts of injected wastewater and water, and the real concentration of the wastewater will be displayed on the monitor 112 based on calculation of the data transmitted from the concentration detector 108. Discharge rate of wastewater from the collecting tank 105 is then determined and controlled within a safe range.

Additionally, as concentration is measured using the concentration detector 108, pH value of the mixture in a measuring tank 102 can be measured by using the pH detector 114. Please be noted that, if the pH value of the mixture shown on the monitor 112 is between 5 and 9, the control valve 128 will be opened so as to let pH-adjusting reagent to flow from the pH-adjusting reagent supply unit 116 to the measuring tank 102 via the pipeline 138. The mixture is thus neutralized and is discharged from the measuring tank 102. According to this invention, the process of discharging the mixture from the measuring tank 102 includes opening the control valve 130 to discharge the mixture which has been measured and neutralized in the mixing tank, and then closing the control valve 130. The injected amount of the pH-adjusting reagent from the supply unit 116 is controlled by the injection time. Moreover, if pH value of the wastewater (e.g., hydrofluoric acid) is less than 5, the pH-adjusting reagent is an alkaline solution (e.g., aqueous sodium hydroxide), but if pH value of the wastewater is more than 9, the pH-adjusting reagent is an acidic solution. The control valve 128 is subsequently closed.

It is worthy to be noted that, when the value of wastewater concentration shown on the monitor 112 is equal to the upper threshold value of the concentration detector 108, the actual wastewater concentration may be higher than or equal to the value shown on the monitor 112. Thus, in order to obtain a reliable data, the measurement must be retaken following the above procedure, while the mixture is further diluted through an adjustment of the injection time for injection from the wastewater supply unit 106 or the water supply unit 104 into the mixing tank 100. The foregoing steps can be repeated until the value of concentration shown on the monitor 112 is less than the upper threshold value of the concentration detector 108. Based on the measured concentration, discharge rate from the wastewater-collecting tank 106 is then determined.

Therefore, the present invention provides a method, by which, a sample of wastewater taken from a collecting tank is first diluted, the concentration of the sample is measured, and, based on the measurement, the real concentration of the wastewater in the collecting tank is then calculated. The dilution steps can be carried out multiple times so as to make the concentration detected by the detector lower than the upper threshold of the detector, for subsequent calculation of real concentration of the wastewater in the collecting tank. Thus, the method can be used to measure reliably wastewater concentration and to determine accurately an appropriate discharge rate from the collecting tank to treatment facilities.

The present invention also provides a method, by which, concentration of wastewater of a substantially high concentration can be accurately measured through multiple dilutions, so that more expensive concentration detectors with higher threshold are not required, and hence cost of the measurement apparatus can be reduced.

Further, the method of the present invention provides a process of automatic control, wherein, an operator needs only to enter relevant parameters into the controller, and then the controller enables each of the measuring units to be operated in an automatic mode. Thus, the operator can monitor the whole measuring process through a monitor.

In addition, the aforementioned apparatus and method for measuring wastewater concentration is not limited to be used merely in manufacturers of semiconductor. The apparatus and method can be used in other manufacturers, such as chemical plants or textile plants, for determining discharge rate of wastewater to treatment facilities.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

1. An apparatus of measuring wastewater concentration for determining discharge rate of wastewater from a wastewater-collecting tank, the apparatus comprising:
a mixing tank having a first pipeline;
a measuring tank communicated with the mixing tank via the first pipeline;
a water supply unit having a second pipeline, wherein the water supply unit is communicated with the mixing tank via the second pipeline;
a wastewater supply unit having a third pipeline, wherein the wastewater supply unit is communicated with the mixing tank via the third pipeline and is communicated with the wastewater-collecting tank;
a concentration detector located in the measuring tank;
a controller connected electronically with the water supply unit, the wastewater supply unit, and the concentration detector, respectively; and
a monitor connected electronically with the controller for displaying operating status of the water supply unit, the wastewater supply unit, and the concentration detector.

2. The apparatus of measuring wastewater concentration as in claim 1, further comprising a pH detector located in the measuring tank.

3. The apparatus of measuring wastewater concentration as in claim 2, further comprising a pH-adjusting reagent supply that has a fourth pipeline and is communicated with the measuring tank via the fourth pipeline.

4. The apparatus of measuring wastewater concentration as in claim 1, further comprising a stirrer installed in the mixing tank.

5. The apparatus of measuring wastewater concentration as in claim 1, further comprising a stirrer installed in the measuring tank.

6. The apparatus of measuring wastewater concentration as in claim 1, further comprising a first control valve, a second control valve, and a third control valve, wherein, the first control valve is installed on the first pipeline between the mixing tank and the measuring tank, the second control valve is installed on the second pipeline between the water supply unit and the mixing tank, and the third control valve is installed on the third pipeline between the wastewater supply unit and the mixing tank.

7. The apparatus of measuring wastewater concentration as in claim 6, wherein the controller is electronically connected with the first control valve, the second control valve and the third control valve, respectively, and operating status of the first control valve, the second control valve and the third control valve is displayed on the monitor.

8. A method of measuring wastewater concentration for determining a discharge rate of wastewater from a wastewater-collecting tank, the method comprising steps of:
taking a certain amount of the wastewater from a wastewater-collecting tank to be diluted with a certain amount of water so as to obtain a first mixture; and
measuring a concentration of the first mixture by using a concentration detector, for calculating a real concentration of the wastewater in the wastewater-collecting tank and then determining a discharge rate of the wastewater from the wastewater-collecting tank.

9. The method of measuring wastewater concentration as in claim 8, wherein, if the concentration of the first mixture is measured by the concentration detector as equal to an upper threshold of the concentration detector, the method further comprising steps of:
retaking a certain amount of the wastewater from the wastewater-collecting tank to be further diluted with a certain amount of water so as to form a second mixture; and
measuring a concentration of the second mixture by using the concentration detector, for calculating the real concentration of wastewater in the wastewater-collecting tank and then determining the discharge rate of the wastewater from the wastewater-collecting tank.

10. The method of measuring wastewater concentration as in claim 8, wherein the step of measuring concentration of the first mixture further comprises a step of measuring a pH value of the mixture.

11. The method of measuring wastewater concentration as in claim 10, wherein, if the pH value of the first mixture is not between 5 and 9, a pH-adjusting reagent is added into the first mixture to adjust the pH value, and the first mixture is discharged thereafter.
